(19) United States
(12) Patent Application Publication
(10) Pub. No.: US 2010/0332358 A1
(43) Pub. Date: Dec. 30, 2010

(54) SYSTEM AND METHOD OF TRACING ITEMS

(76) Inventor: Bryan K. Owens, Atlanta, GA (US)

Correspondence Address: BUTZEL LONG;IP DOCKETING DEPT, 350 SOUTH MAIN STREET, SUITE 300, ANN ARBOR, MI, 48104, US

(21) Appl. No.: 12/665,655

(22) PCT Filed: Jun. 23, 2008
(86) PCT No.: PCT/US08/67903

§ 371 Date: Dec. 18, 2009

Related U.S. Application Data
(60) Provisional application No. 60/945,411, filed on Jun. 21, 2007.

(51) Int. Cl. G06Q 10/00

(52) U.S. Cl. 705/28

(57) ABSTRACT

A system and method of managing items mishandled during transit using a computer system includes the steps of finding an unclaimed item on hand and creating a record for identifying the on hand item using predetermined attributes, and each of the predetermined attributes is assigned a predetermined weight. A record for a mishandled item is created using the attributes. It determines if each mishandled item attribute compares with the corresponding on hand item attribute and if comparable, determining a percentage match using the assigned attribute weight. An overall percentage match between the lost item and the on hand item is calculated by summing together the weighted percentage match for each compared attribute pair. The overall percentage match is compared to a match threshold to correlate the on hand item with a claim for the mishandled item if the overall percentage match is above the predetermined match threshold.

### FIELD OF THE INVENTION

The present invention relates to tracing of items, and in particular to a system and method of interactively tracing a misplaced item.

### BACKGROUND OF THE INVENTION

The transportation industry facilitates the movement of both passengers and goods between locations. While most goods arrive at the intended location in an acceptable condition, some do not. For the air transport sector, lost, misplaced, pilfered or otherwise mishandled baggage is a primary passenger concern. Although systems are available for tracking baggage, current systems are not interactive and are only marginally successful in matching mishandled or lost items with its intended owner. In addition, communication between multiple locations or between airlines is limited.

Thus, there is a need in the art for an internet-based system and method of managing and facilitating the tracing of mishandled items between multiple locations and across multiple organizations.

Advantageously, a system and method of tracing transportable goods is provided. The system includes a main computer system having a server and a data storage device at a central location and a local computer system having a processor and input device and a display screen at a secondary location that is operatively in communication with a main computer system via a communications network.

The method includes the steps of finding an unclaimed item on hand and creating a record for identifying the on hand item using an item tracing software program resident on the computer system. The on hand item record includes predetermined attributes describing the on hand item. The methodology creates a record for a mishandled item using the item tracing software program, and the mishandled item record includes predetermined attributes describing the mishandled item. The methodology determines if there is a match between each mishandled item record and each corresponding on hand item record using the item tracing software program. The item tracing software program assigns a predetermined weight to each on hand item attribute and each mishandled item attribute, compares each lost item attribute to each corresponding on hand item attribute to determine if there is a comparison between each on hand item attribute and mishandled item attribute pair. If they compare, the methodology determines a percentage match for each compared attribute pair using the assigned weight for each attribute. The methodology determines an overall percentage match between the lost item and the on hand item by summing together the weighted percentage match for the compared attribute pairs. The methodology compares the overall percentage match to a predetermined match threshold to determine if there is a match between the on hand item and the mishandled item claim, and uses the overall percentage match to correlate the on hand item with a claim for the mishandled item.

An advantage of the present invention is that an internet-based system and method for tracing items and claims resolution is provided. Another advantage of the present system and method is that a user-friendly web-based interface is provided that is easy to use and minimizes user training. Still another advantage of the present invention is that the user can easily cross-reference on-hand items in a particular location with incident reports. Yet another advantage of the present invention is that if an initial match is not made between an on-hand item and an incident report, tracing automatically continues until resolution. A further advantage of the present invention is an integrated task management feature is provided that includes invocable interfaces that can be accessed in a user-defined sequence. Yet a further advantage of the present invention is that it is compatible with other systems, such as a passenger reservation system. Still a further advantage of the present system is that it is scalable to multiple users. Yet still further advantage of the present invention is that it can be integrated with RFID technology.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a diagrammatic view of a system for tracing an item that has been mishandled while in transit.

FIG. 2 is a flowchart illustrating a method of tracing the item using the system of FIG. 1.

FIG. 3 is a flowchart illustrating a method of managing the mishandled item using the system of FIG. 1.

FIG. 4 is a flowchart illustrating a method of matching an on hand item with a lost

FIG. 5 is a diagrammatic view of a display screen illustrating user selectable options for managing a mishandled item using the system of FIG. 1.

FIG. 5 is a diagrammatic view of a display screen illustrating user selectable options for managing a mishandled item.

FIG. 6 is a diagrammatic view of a display screen illustrating a drop down menu of user selectable options for managing a mishandled item.

FIG. 7 is a diagrammatic view of a display screen illustrating the incoming bag task management option.

FIG. 8 is a diagrammatic view of a display screen illustrating the incoming request task management option.

FIG. 9 is a diagrammatic view of a display screen illustrating the mass on hand task management option.

FIG. 10 is a diagrammatic view of a display screen illustrating a drop down menu of user selectable options for managing a lost or delayed item.

FIG. 11 is a diagrammatic view of a display screen illustrating user selectable options for viewing a lost or delayed item.

FIG. 12 is a diagrammatic view of a display screen illustrating user selectable options for adding a lost or delayed item.

FIG. 13 is a diagrammatic view of a display screen illustrating a drop down menu of user selectable options for managing a damaged item.

FIG. 14 is a diagrammatic view of a display screen illustrating user selectable options for viewing a damaged item.

FIG. 15 is a diagrammatic view of a display screen illustrating a drop down menu of user selectable options for managing a pilfered item.

FIG. 16 is a diagrammatic view of a display screen illustrating a drop down menu of user selectable options for managing an on hand item.

FIG. 17 is a diagrammatic view of a display screen illustrating user selectable options for adding the on hand item.

FIG. 18 is a diagrammatic view of a display screen illustrating user selectable options for adding a plurality of on hand items.

FIG. 19 is a diagrammatic view of a display screen illustrating a drop down menu of user selectable options for lost or found items.

FIG. 20 is a diagrammatic view of a display screen illustrating user selectable options for adding the lost or found item.

FIG. 21 is a diagrammatic view of a display screen illustrating a drop down menu of user selectable options for tracing to identify a match between an on hand item and a mishandled item.

FIG. 22 is a diagrammatic view of a display screen illustrating a report of identified matches.

FIG. 23 is a diagrammatic view of a display screen illustrating a drop down menu of user selectable report options.

FIG. 24 is a diagrammatic view of a display screen illustrating user selectable options for creating a report.

FIG. 25 is a diagrammatic view of a display screen illustrating a drop down menu of user selectable options for performing administrative tasks.

FIG. 26 is a diagrammatic view of a display screen illustrating user selectable options for administering users at a location.

FIG. 27 is a diagrammatic view of a display screen illustrating a drop down menu of user selectable options for managing a claim.

FIG. 28 is a diagrammatic view illustrating user selectable options for viewing a claim.

### DETAILED DESCRIPTION

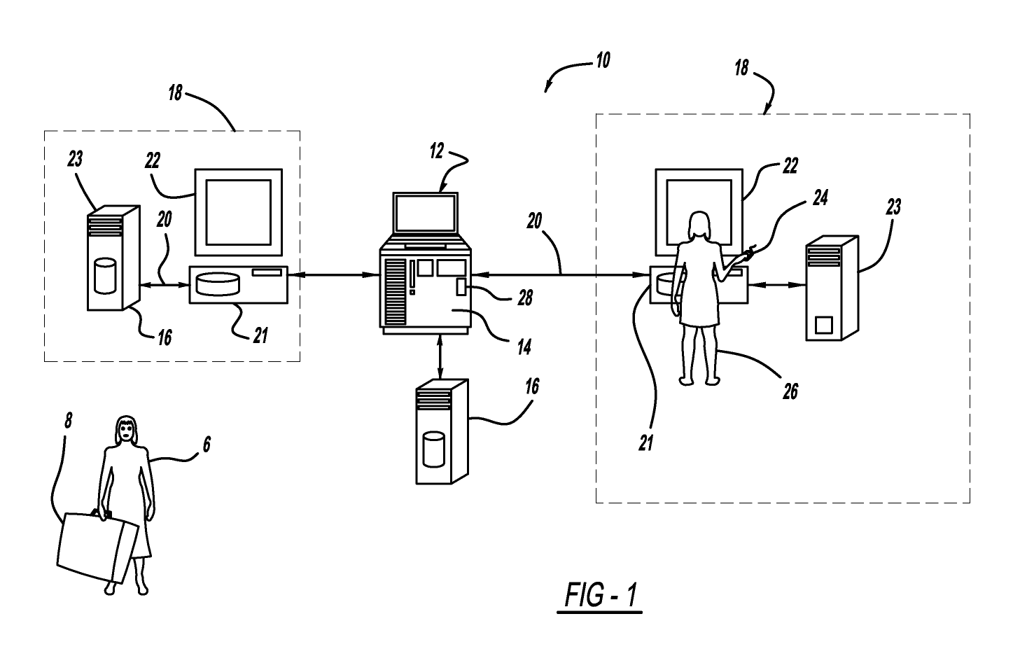

Referring to FIG. 1, an example of a system 10 for implementing the methodology of tracking items 8 is illustrated. By way of illustration, the item 8 is baggage that is transported within the air transport sector, although the system 10 and methodology can be utilized with other types of goods or transport sectors.

The system 10 includes a centralized tracing computer system 12. The centralized tracing computer system 12 includes a server 14 and an associated data storage device 16.

The centralized tracing computer system 12 is in communication with a secondary or local computer system 18 via a communications network 20. The communications network 20 may be wired or wireless, or a combination thereof. The communications network 20 may include an internet or an intranet. The local computer system 18 includes a processor 21 having an associated memory and a data storage device 23. Information regarding a misplaced item or on hand items may be stored in the local data storage device 23 or the central data storage device 16. The local computer system 18 may also include a display device 22 such as a display terminal or the like, and an input device 24 such as a mouse or a keypad or the like. The input device 24 provides for the selection and control of information provided on the display terminal. An example of a display technique is a window containing a pop-up dialogue box or drop down menu or the like containing information, such as selective options or instructions pertaining to the method of tracking items to be described. The user selects from the provided options using the input device 24, and is provided additional information. The additional information may be provided in a new window. The user may return to a previous window or advance to a new window by selecting a designated option. The local computer system 18 is accessible by a user 26, such as an individual, that utilizes the local computer system 18 in tracing items. In this example, the user 26 may be associated with a particular airline, or with a baggage handling organization affiliated with the airline. The user 26 may be located at an airport or at a centralized baggage handling facility or the like. The system 10 may include a plurality of local computer systems at different physical locations, each affiliated with a different organization, such as different airlines. The local computer systems may be in communication with each other either directly, or through the centralized tracing computer system 12, via the communications network 20.

Further, the centralized tracing computer system 12 or the local computer system 18 may operatively be in communication with other transport related systems, such as an airline reservation system 10, or an airline baggage handling system 10 or the like.

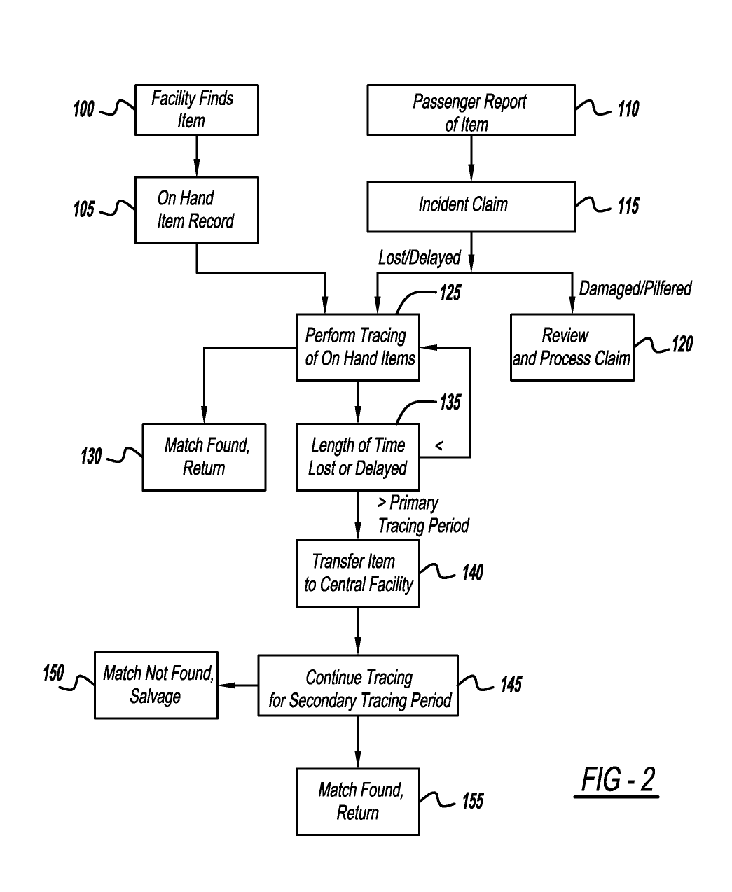

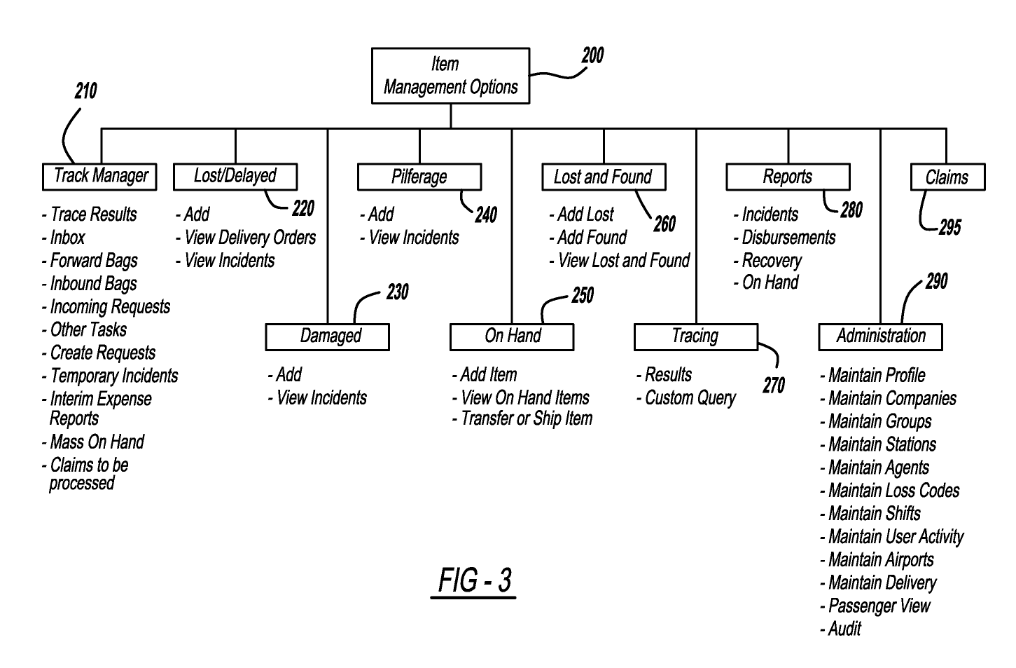

The system 10 includes a software program 28 for tracing items by matching on-hand items with incident or claim reports and claims resolution. The tracing software program 28 may be resident on the centralized tracing computer system 12 or on a local computer system 18. It should be appreciated that the tracing software program 28 may be in communication with other tracing systems. The user 26 accesses the tracing software program 28, and is presented with a series of screens or windows containing predetermined information. The user 26 may select an option using the input device 24, and is guided through the tracing process. A methodology for managing and tracing an item using the tracing software program 28 is illustrated in FIGS. 2-3.

Referring to FIG. 2. an overall method of managing a mishandled item is provided. The methodology begins in block 100 with a user 26 finding an unclaimed item. For example, the item 8 may be unclaimed at a baggage area for an airline. The methodology advances to block 105 and a user 26 creates a record for the on hand item using the tracing software program 28. The methodology advance to block 125, to be described.

In block 110, an individual, such as a passenger 6, discovers that an item being transported has been mishandled. For example, the airlines passenger 6 arrives at a destination and discovers that their luggage is lost, delayed, damaged, or pilfered. The methodology advances to block 115, and a loss incident claim is entered into the system 10 using the tracing software program 28. The lost incident claim contains information pertaining to the passenger and description information relative to the item 8 being claimed. The claim may be for a delayed in transport item, a lost item, a damaged item or a pilfered item or the like. The claim information includes details such as flight number, item type, claim check number, damage description or the like. If the claim is for a lost or delayed item, the methodology advances to block 125 and it is determined if there is a match between the lost or delayed item and items on hand using the tracing feature of the tracing software program 28. If a match is found, the methodology advances to block 130 and the item is returned. For example, the user 26 may utilize a shipping feature of the tracing software program 28 to transport the item to the passenger. If a match is not found, the methodology advances to block 135 and it is determined how long the item has been lost or delayed. If the item has been lost or delayed less than a predetermined initial period of time, the item is held for a predetermined primary tracing period. An example of an initial period of time is 5 days. The methodology returns to block 125 and tracing continues. If the item has been lost or delayed more than a predetermined initial period, than the methodology advances to block 140 and item is transferred to a central facility for storage. The methodology advances to block 145 and the item is held for a secondary period of time, such as 60 days, and tracing continues during the secondary period. If a match is not found during the secondary period, the methodology advances to block 150 and item is transferred to a salvage facility. If a match is found during the secondary period, the methodology advances to block 155 and the item is returned to its owner.

Returning to block 115, if the incident claim is for a damaged item, the methodology advances to block 120 and the claim is reviewed by the user 26 for disposition. The user 26 may elect a course of action, such as restitution, repair or denial.

Referring to FIG. 3, a methodology for managing tracing of a mishandled item and claims resolution by the user 26 is illustrated. It should be appreciated that the methodology is implemented by the tracing software program 28.

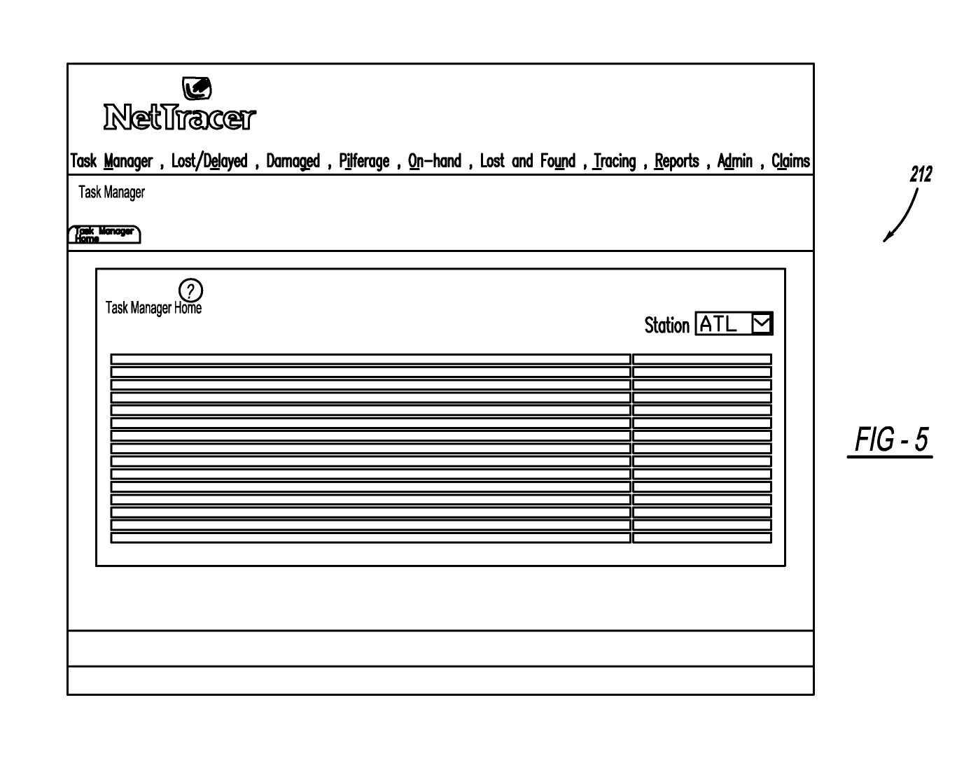

The methodology begins in block 200 with the step of providing the user 26 with a display screen offering a plurality of user 26 selectable options for managing tasks associated with item tracing and claims resolution of mishandled items during transport. For example, the options may be presented in the form of tabs, and the user 26 selects a particular tab to perform a predetermined task, as shown in FIG. 5 at 212.

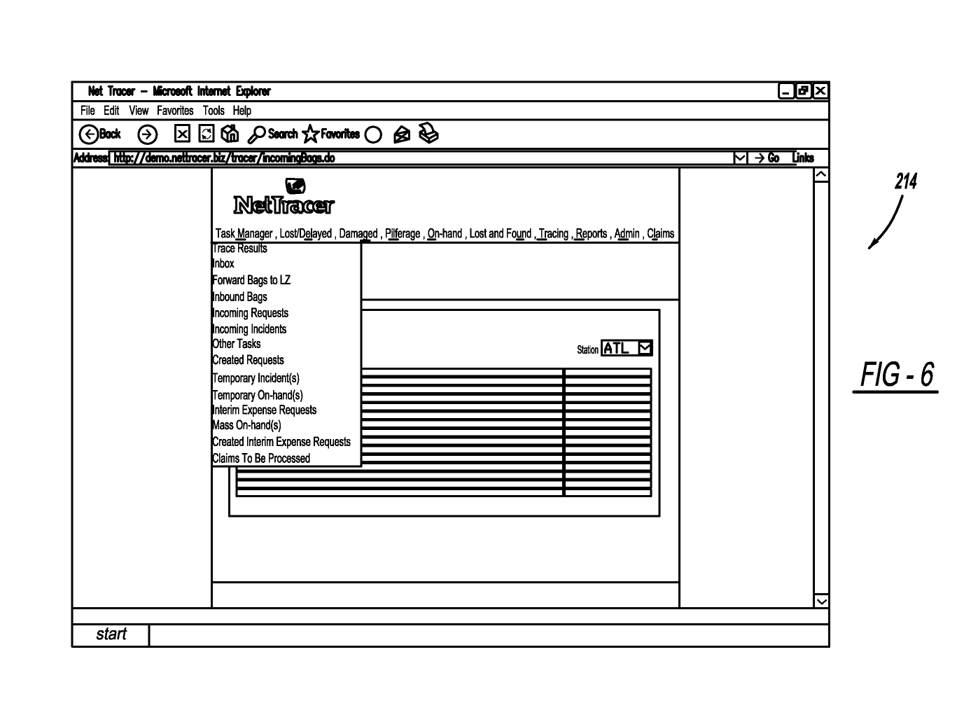

Returning to block 200, if the user 26 selects a task manager tab, the methodology advances to block 210 and the user 26 is provided with a screen or window of further options for managing the work routines for a particular station or associated with a claim as it moves through the tracing process, as shown in FIG. 6 at 214. If the user 26 selects the trace results option, the user 26 is presented with a screen containing a list of on-hand bags matching incidents described in a lost/delayed item report for a particular station. The tracing may automatically occur on a periodic basis, such as once a day. Within the passive tracing activity, the matches may be grouped within predetermined categories. For example a first category groups matches on primary identifiers, such as claim check, frequent flyer number, email or other such attributes having a high level of confidence, such as over 85%. A second category groups matches on secondary identifiers, such as color, style, or the like, and offers a medium level of confidence, such as between 20%-85%. In addition, the trace results may also be filtered using user 26 defined filter options or searched using user 26 defined search options. The user 26 can select on a particular report item number to obtain further detailed information for that incident. Based on the detailed information associated with an incident report, the user 26 can selectively confirm a match based on a trace result, or reject a trace result or the like. For a successful match, the user 26 can initiate a transfer request for an on hand item to unite the item with its owner.

If the user 26 selects the inbox, the user 26 is presented with a screen that allows the user 26 to communicate with others via an electronic message, such as an email or an instant message or a text message or the like. The user 26 may be able to manage messages, such as to reply, or delete or forward a message or the like to others. The other may be within the same organization or outside the organization.

If the user 26 selects the forward bags option, a list of on-hand report numbers that apply to items physically present at a particular location and that need to be sent to a predetermined central location for further tracing is provided. For example, the central location may provide secondary tracing after a primary tracing period has expired. The central tracing location is a centralized location for storing lost items. The central tracing location performs additional or secondary tracing in order to identify the owner of the item. It should be appreciated that items are transferred to a central location if they have been on-hand for a predetermined number of days, such as 5 days. Within the task manager option, the user 26 may identify the item to be sent to the central tracing location, identify the central tracing location, and prepare an itinerary and other arrangements for transporting the item to the central tracing location. For example, the user 26 can schedule the item to be placed on a flight, and document relevant flight information for future reference.

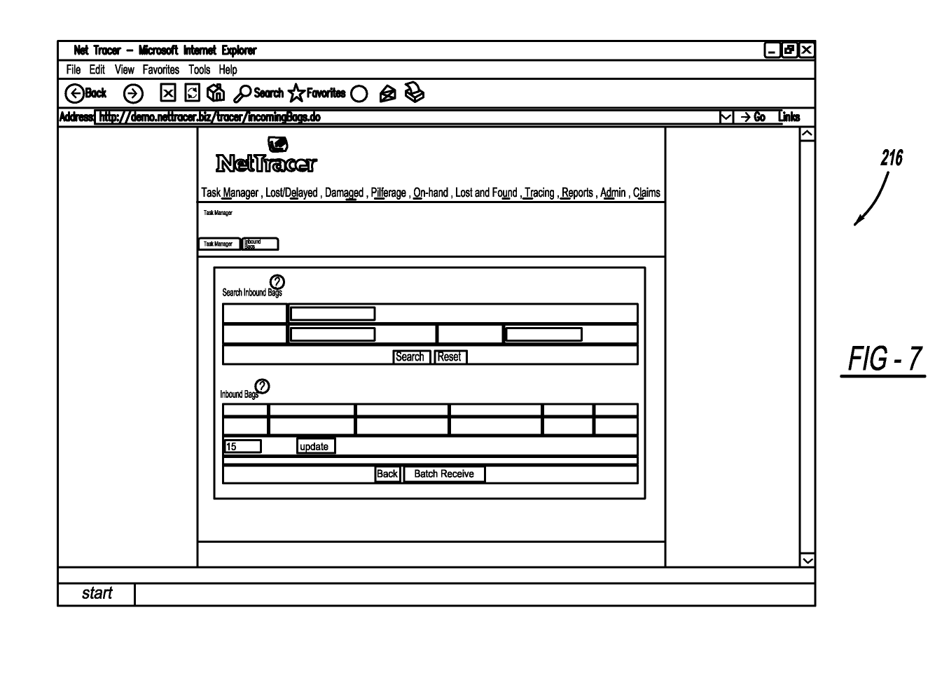

If the user 26 selects an inbound bags option, the user 26 is provided with a screen listing found items that are being forwarded to the user 26 for handling as shown in FIG. 7 at 216. The user 26 can selectively obtain additional details about an incoming item, or confirm that the item has been received, or the like. For example, the user 26 may click on an incident number or enter an incident number, and a screen if provided containing detailed information regarding the item,

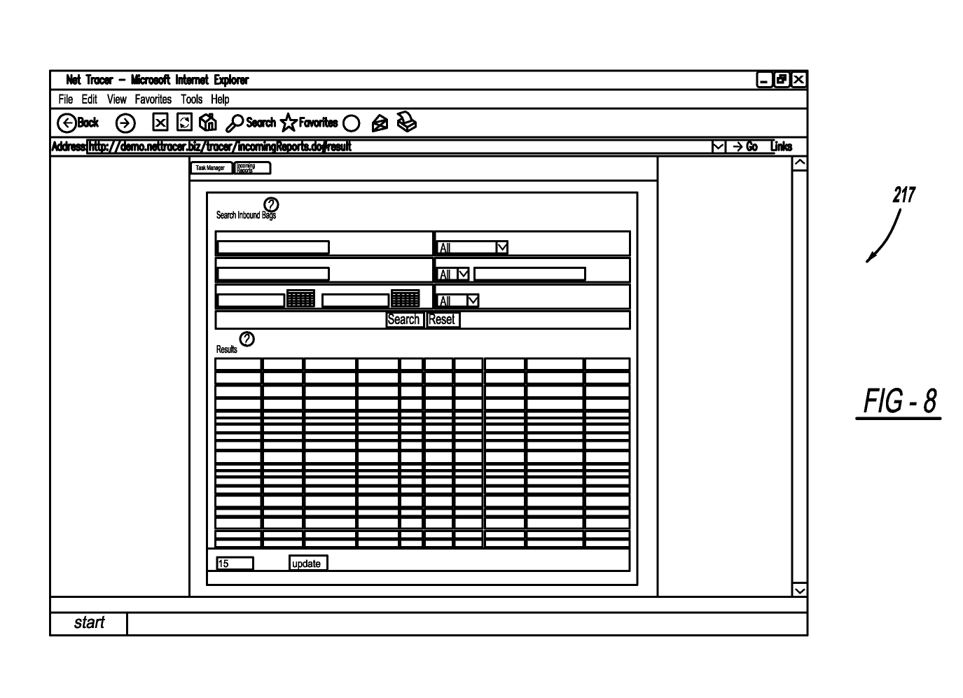

If the user 26 selects an incoming request option, the user 26 is provided with a display screen containing a list of requests that have been made by other stations for on-hand items physically located at the user 26's particular station as shown at 217 of FIG. 8. For example, the user 26 can obtain additional information for a particular incoming request by selecting a details option for the associated incident number. The user 26 may selectively approve or deny an incoming request. The user 26 may selectively arrange to have the requested item transferred to the particular requestor.

If the user 26 selects the incoming incidents option, the user 26 is provided with a display screen containing a list of incoming items to the user 26's location that have been damaged or pilfered. The user 26 can selectively obtain additional information for a particular incoming incident by clicking on a details option for that report number. The user 26 may selectively make arrangements for restitution to the item owner.

If the user 26 selects an other tasks tab, the user 26 is provided with a list of predetermined activities assigned to a specific location. The activities may be assigned a priority, such as high, medium or low or the like. The user 26 may search for a specific task within the list of predetermined activities, edit an existing activity, create a new activity or mark an activity as completed.

If the user 26 selects a view create requests tab, and the user 26 is provided with a screen displaying a list of requests for found items made by the user 26's location for on-hand items that are being held by another location, and match mishandled item reports that are assigned to a particular location, such as the user 26's location. The user 26 may selectively obtain additional detail regarding a created request for an item, perform a search the requests, deny a request or forward an item to another location or to the owner.

If the user 26 selects a temporary incident tab, the user 26 is provided with a screen listing incoming items to the user 26's location that have been damaged or pilfered. The user 26 may selectively view additional information for a particular temporary incident by selecting a details option for the associated incident. The user 26 can make arrangements for restitution to the owner of the item. Similarly, the user 26 may select a temporary on-hand report and obtain a list of items temporarily located at the user 26's location. The user 26 may obtain further information about a particular item, arrange for the disposition of the item, or arrange for restitution to the owner.

The user 26 may select an interim expense request, and the user 26 is provided with a window containing a list of requests for reimbursement of interim expenses incurred due to the incident. The user 26 may selectively approve or deny such requests. In addition, the user 26 can create an interim expense request by selecting a designated tab.

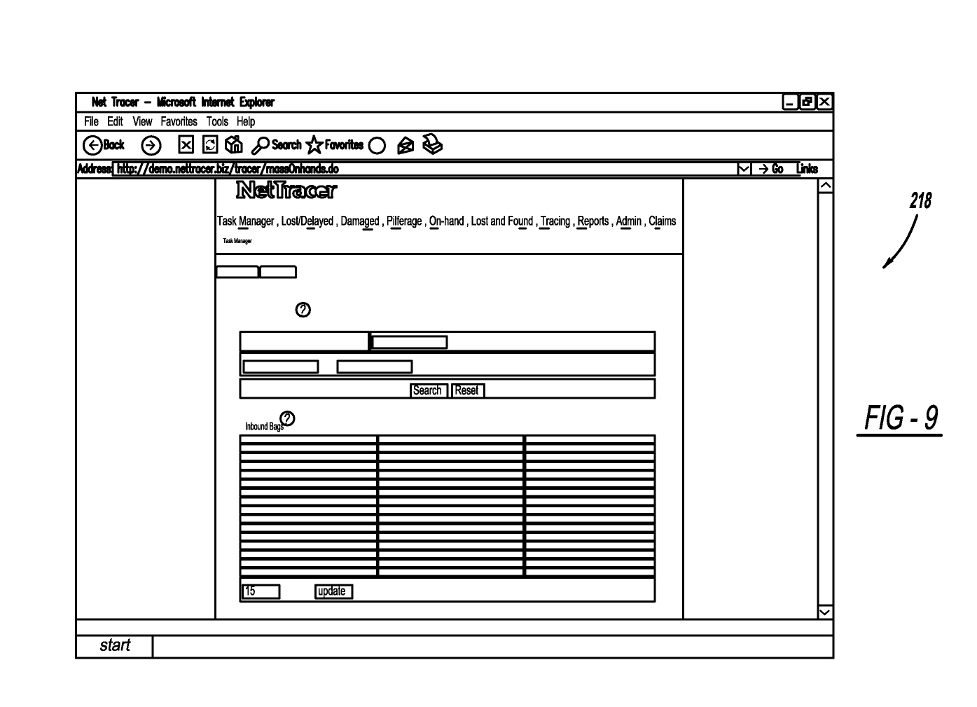

The user 26 may select a mass on-hand tab, and the user 26 is provided with a screen displaying items that have been at a predetermined location, such as the user 26's location, for a designated period of time as shown in FIG. 9 at 218. For example, the user 26 may selectively view incident reports for items that have been at the central storage facility for over 30 days.

The user 26 may select a claims to be processed tab, and the user 26 is provided with a list of lost damaged or pilfered items for which a claim has been submitted by an owner of the item. The user 26 may process the claim in a predetermined manner. For example, the user 26 may approve the claim, deny the claim or otherwise settle the claim with the owner.

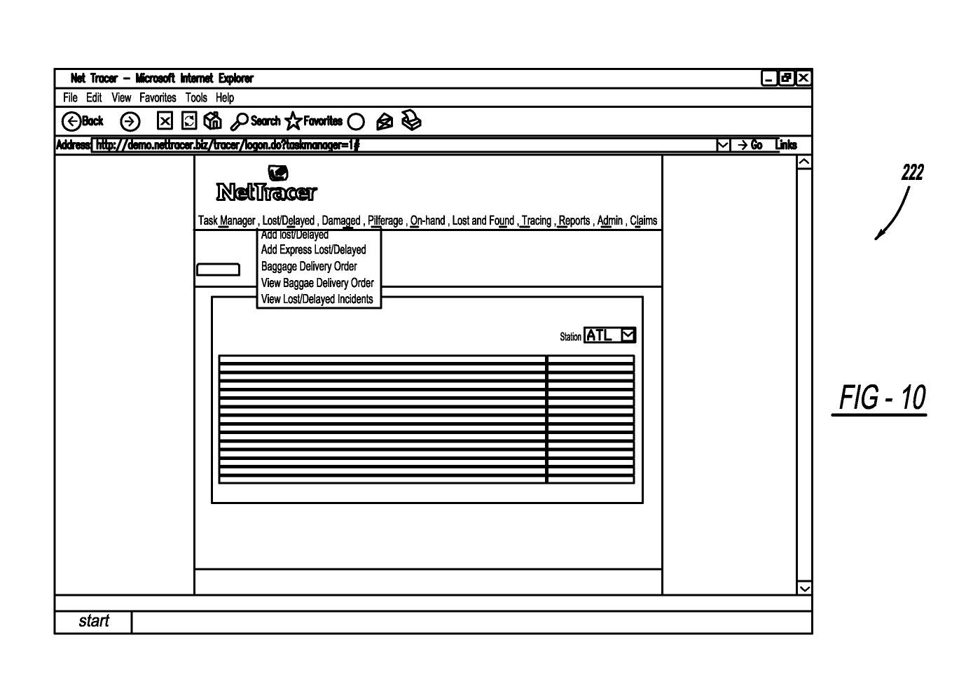

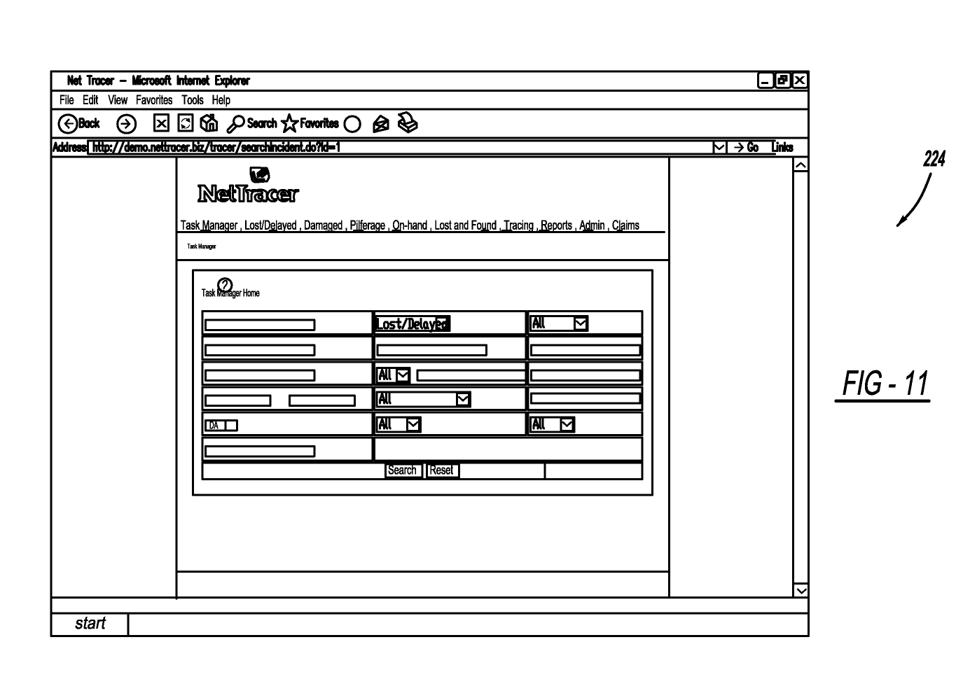

Returning to block 200, if the user 26 selects a lost or delayed tab, the methodology advances to block 220 and the user 26 is provided with a screen for logging and tracing baggage that does not match with a passenger at a predetermined destination associated with the passenger, such as the passenger's final destination or an intermediate location as shown in FIG. 10 at 222. The user 26 can selectively create a record to add a lost item or add a found item as shown in FIG. 11 at 224. In addition, the user 26 may view a list of lost and found items.

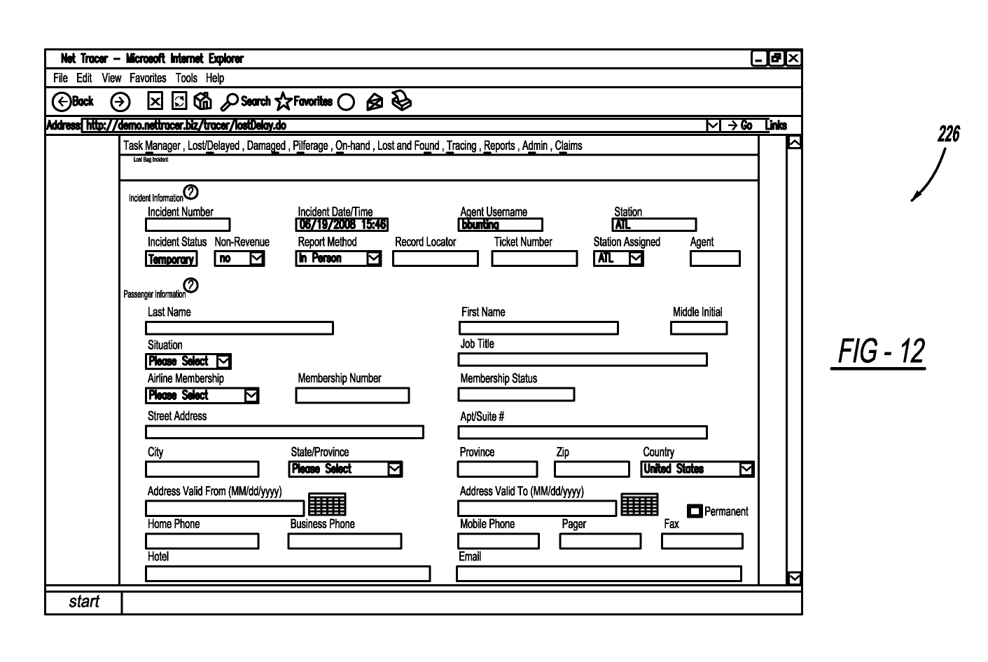

For example, for either lost or found item, the user 26 may create a data record to identify the item using attributes such as incident number, creation date, report status, station, passenger airline record locator, ticket number, passenger name, airline membership, contact address, passenger itinerary, baggage itinerary, baggage check location, baggage received, claim check number as shown in FIG. 12 at 226. The user 26 may also enter information pertaining to physical characteristics or attributes of the bag itself that may be useful in identifying the bag. Examples include name, color, type, external descriptive elements manufacturer, contents. This information may be selected from a drop down list. The user 26 may provide additional remarks, or a reason for the fault or the fault location or the like. The user 26 may selectively save a new record in a predetermined mode, such as a temporary save in a database. In addition, the user 26 may submit the incident record for tracing. The methodology will assign an identifier number, such as a mishandled baggage incident number and try to match the record with open on-hand baggage incident records.

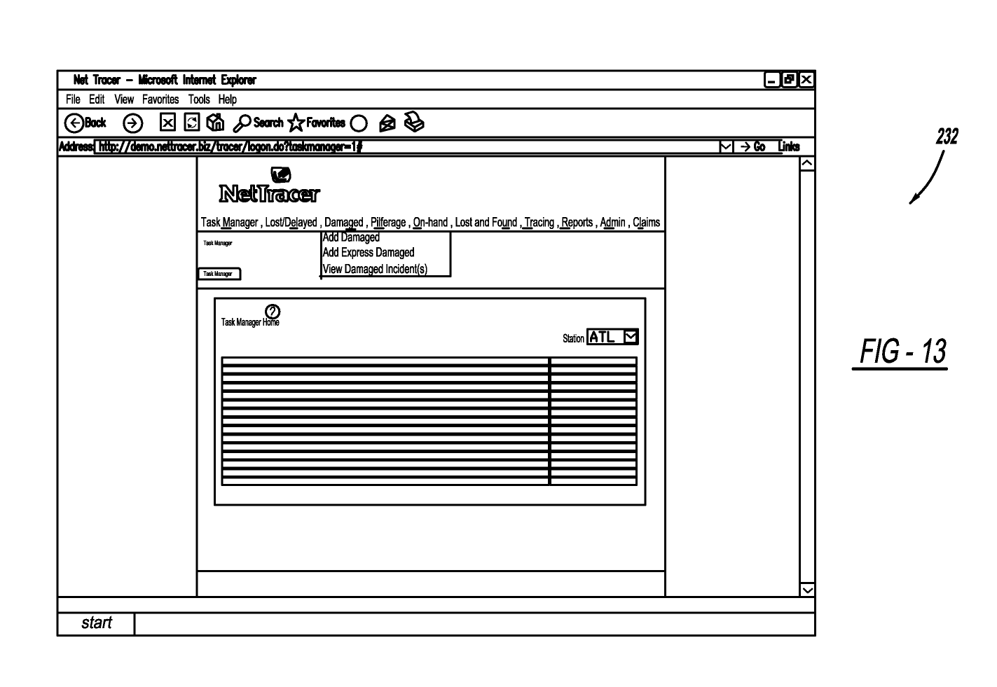

Referring back to block 200, if the user 26 selects a damaged bag option, the methodology advances to block 230 and the user 26 is presented with a screen for logging and tracing items that have been damaged while in transit as shown in FIG. 13 at 232. The user 26 can selectively create an incident record concerning the damaged property. In addition, the user 26 may view a listing of damaged property incident records.

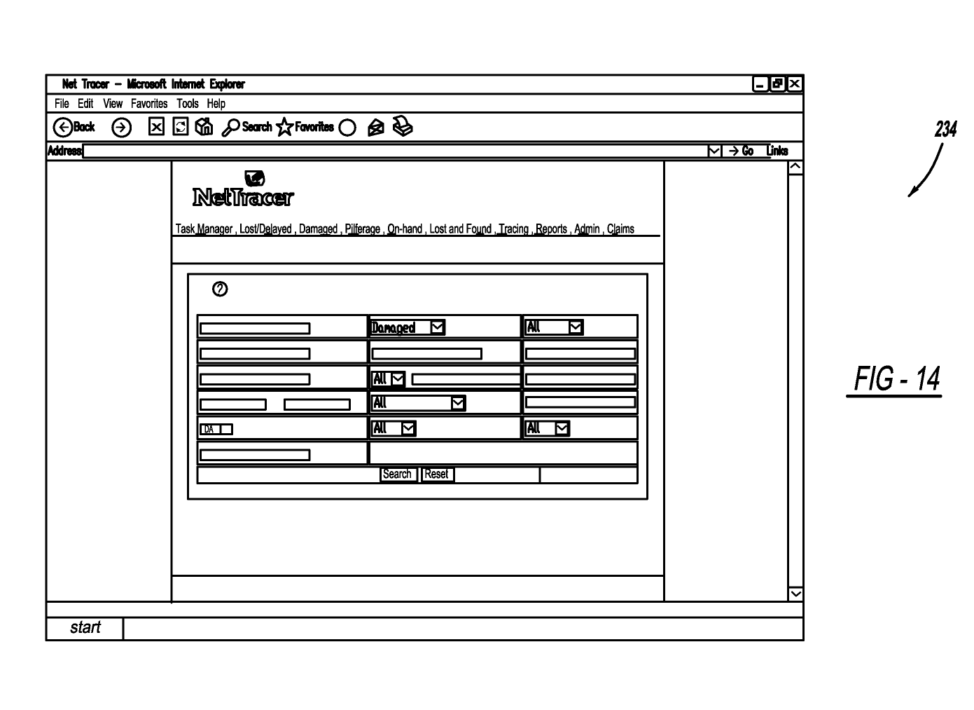

For example, the user 26 may create an incident record identifying the damaged property using identifiers or attributes such as incident number, creation date, report status, station, passenger airline record locator, ticket number, passenger name, airline membership, contact address, passenger itinerary, baggage itinerary, baggage check location, baggage received, claim check number as shown in FIG. 14 at 234. The user 26 may also enter information pertaining to the physical characteristics of the bag itself that may be useful in identifying the bag. Examples include name, color, type, external descriptive elements manufacturer, contents. This information may be selected from a drop down list. The user 26 may provide additional remarks, or a reason for the fault or the fault location or the like. The user 26 may selectively enter an image into the record, such as a photographic image. The user 26 may selectively save a new incident record in a predetermined mode, such as a temporary save in a database. In addition, the user 26 may submit the incident record for tracing. The methodology will assign an incident number, such as a damaged baggage incident number. The user 26 may selectively assess the level of damage and include this information in the incident record. The user 26 may selectively enter information concerning any agreement reached with the item owner regarding restitution for the damage, such as repair or replace. The user 26 may selectively enter information concerning whether the claim was approved or denied, the claim amount, such as cost of the bag or any damaged articles within the bag.

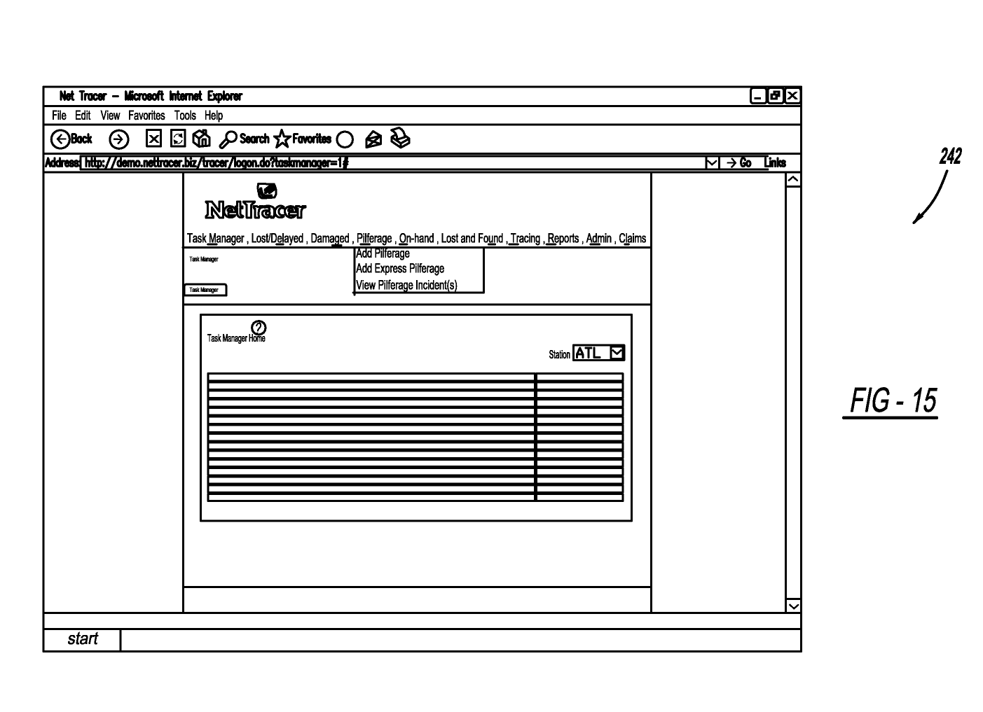

Referring back to block 200, if the user 26 selects a pilfered bag option, the methodology advances to block 240 and the user 26 is presented with a screen for logging and tracing items that has been pilfered while in transit as shown in FIG. 15 at 242. For example, the item may be removed from baggage during transport between locations. The user 26 may selectively create a record file concerning the missing property. In addition, the user 26 may view a list of pilfered item incident reports.

For example, the user 26 may create a pilfered item incident record identifying the pilfered property. The incident record contains data for identifying the pilfered item using attributes such as incident number, creation date, report status, station, passenger airline record locator, ticket number, passenger name, airline membership, contact address, passenger itinerary, baggage itinerary, baggage check location, baggage received, claim check number. The user 26 may also enter information pertaining to the physical characteristics of the bag. Examples include name, color, type, external descriptive elements manufacturer, contents. This information may be selected from a drop down list. The user 26 may provide additional remarks, such as a description of the missing item, or cost. The user 26 may enter an image of the item into the pilfered item incident record, such as a photographic image. The user 26 may selectively save a new pilfered item incident record in a predetermined mode, such as a temporary save in a database. The methodology will assign an identifier number, such as a pilfered baggage record number. The user 26 may enter information concerning any agreement reached with the passenger regarding restitution for the missing item, such as whether the claim was approved or denied, or the claim amount.

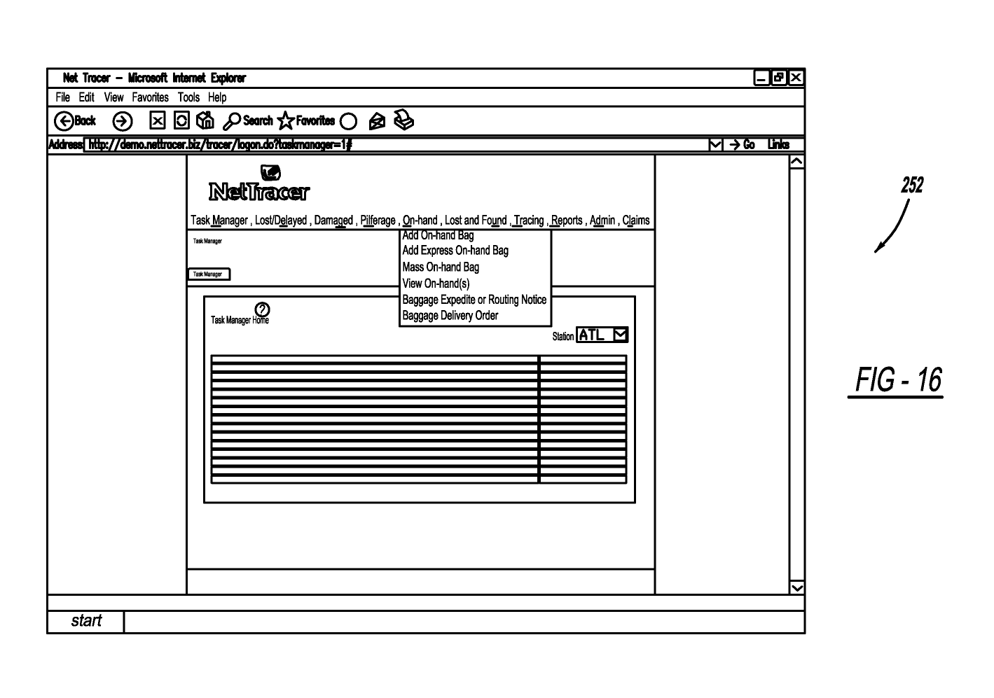

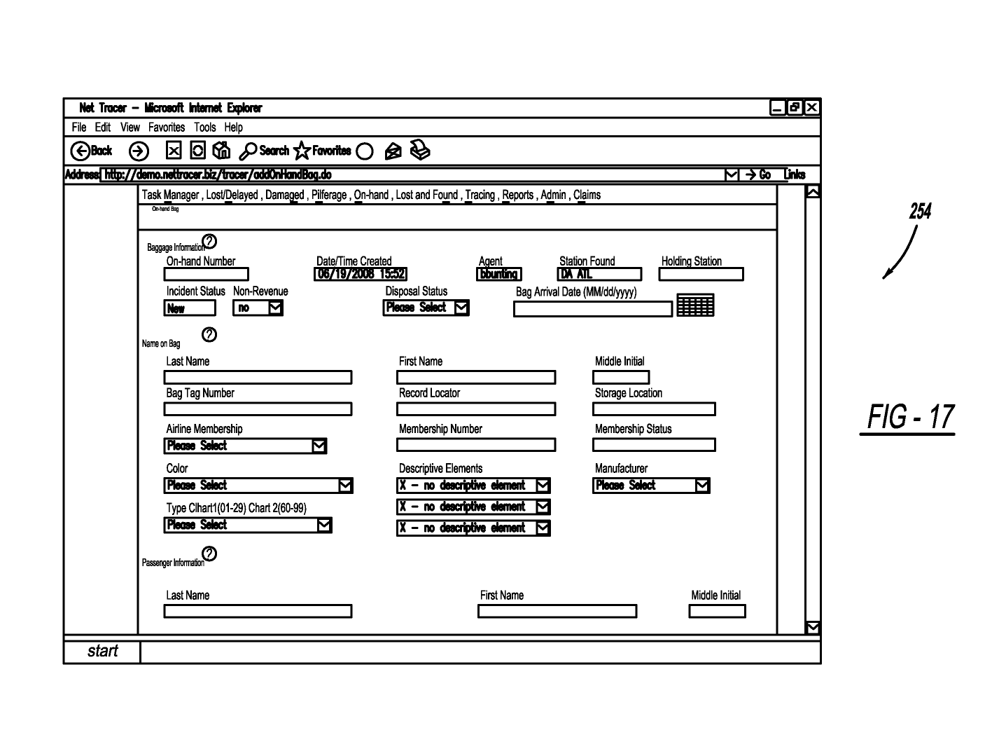

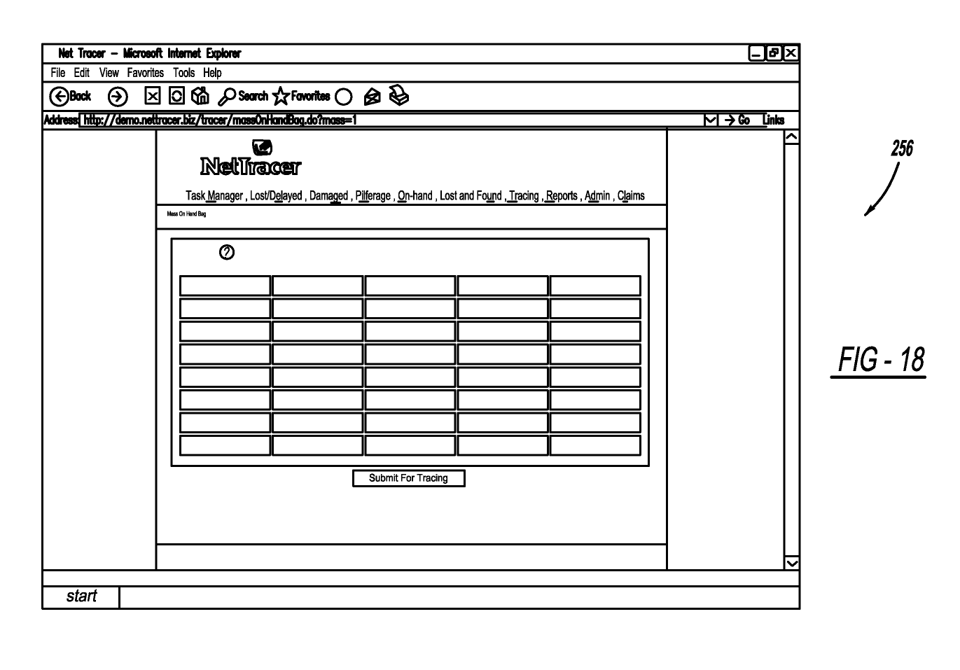

Returning to block 200, if the user 26 selects the on-hand tab, the methodology advances to block 250. In block 250, the user 26 is present with a screen containing various options for managing an on hand item, such as a piece of baggage that is located at a particular location as shown in FIG. 16 at 252. An example of a location is a baggage claim center for a particular airline. The user 26 is present with various options for managing the on hand item. The user 26 may selectively perform a search of on-hand items using a predetermine parameter. The search parameter may be an attribute used to describe the item, such as a found airport code or a airline code, or by date, bag tag number, storage location, airline membership, frequent flier number, record number, or color or type or an external characteristic, or manufacturer as shown in FIG. 17 at 254. The user 26 may selectively search the list of mass on hand items using passenger information, such as name or flight number. The user 26 may enter one or more bags using an identification code, such as bag tag numbers to a mass list of on hand items. In addition, the user 26 may enter a plurality of bag tag codes in a single entry. The methodology may store the mass on-hand data in an associated database for a predetermined period of time, such as 24 hours. After the predetermined period, the methodology may automatically send the bag on-hand Report numbers to a Task Manager file for further action by the user 26 at a particular location.

The user 26 may be presented with additional options, such as to add or delete an on-hand item to the summary of on-hand items. The user 26 may selectively view the on-hand items based on predetermined criteria, such as an attribute. The user 26 may selectively transfer the bag to another location, such as to another airline or another airport to the owner.

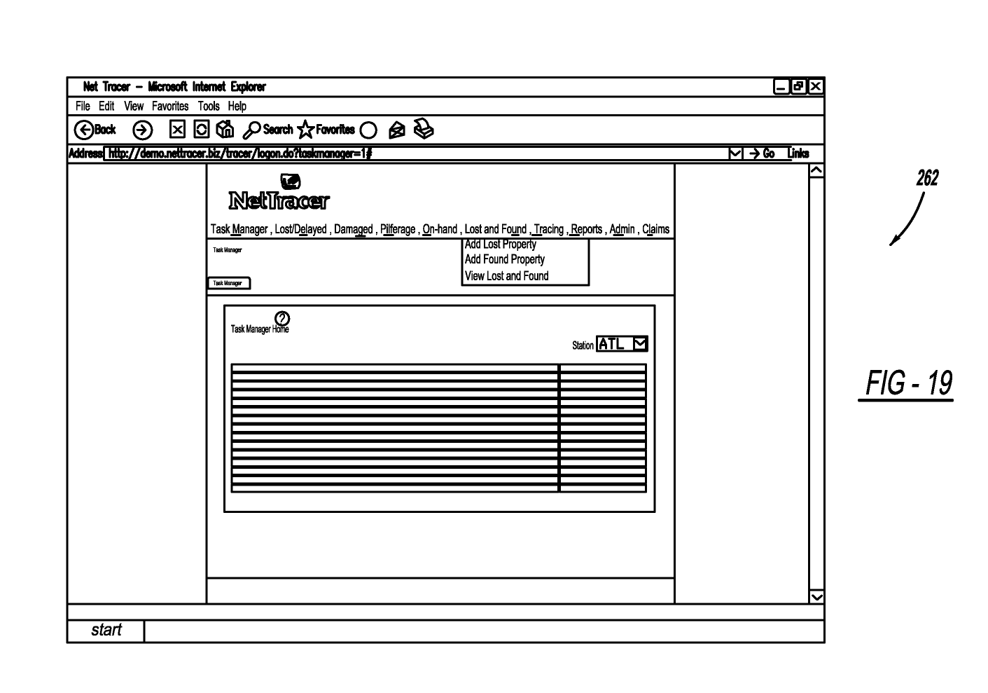

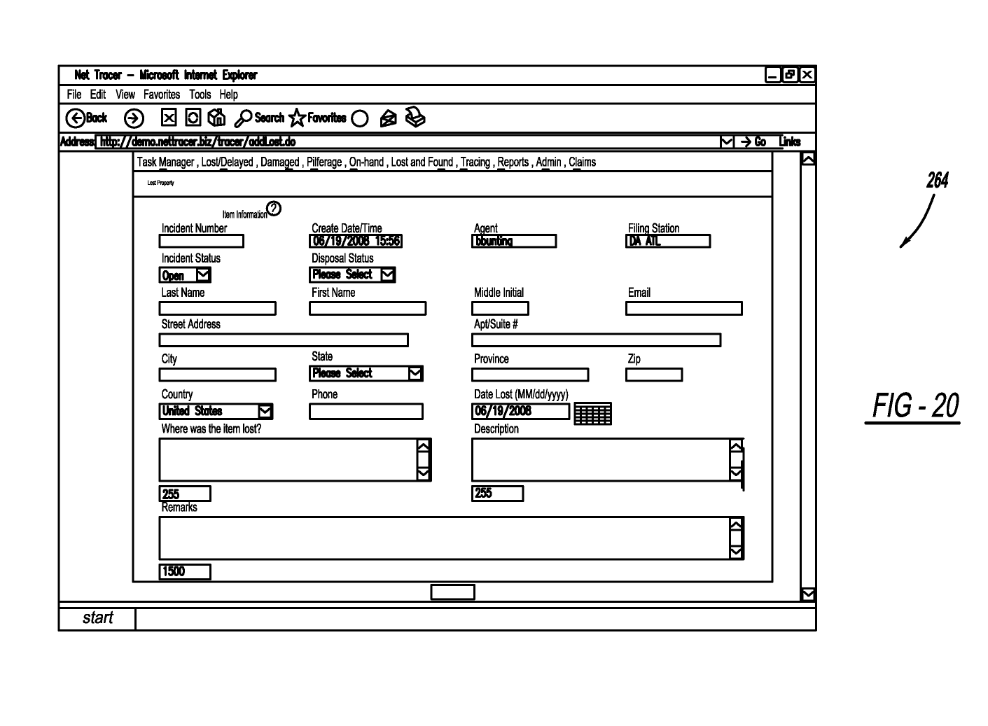

Returning to block 200, if the user 26 selects the lost and found tab option, the methodology advances to block 260. In block 260, the user 26 is present with a screen containing various options for managing an item, such as a piece of baggage that is located lost or found or at a particular location as shown in FIG. 19 at 262. The lost or found record contains data for identifying the lost or found item using attributes such as incident number, creation date, report status, station, passenger airline record locator, ticket number, passenger name, airline membership, contact address, passenger itinerary, baggage itinerary, baggage check location, baggage received, claim check number. The user 26 may also enter information pertaining to the physical characteristics of the lost or found item as shown in FIG. 20 at 264. Examples include name, color, type, external descriptive elements manufacturer, contents. This information may be selected from a drop down list. The user 26 may provide additional remarks, such as a description of the missing item, or cost. The user 26 may enter an image of the item into the item incident record, such as a photographic image

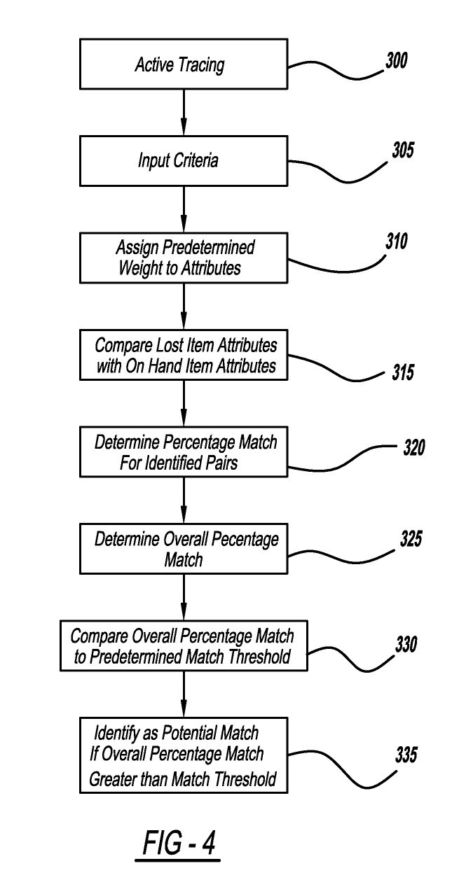

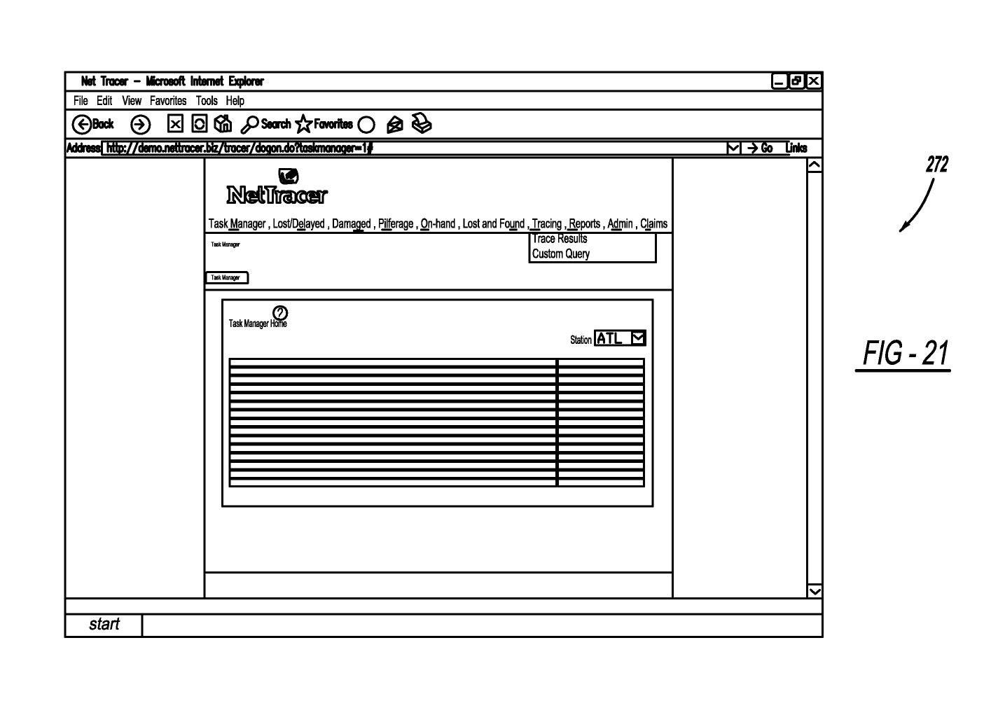

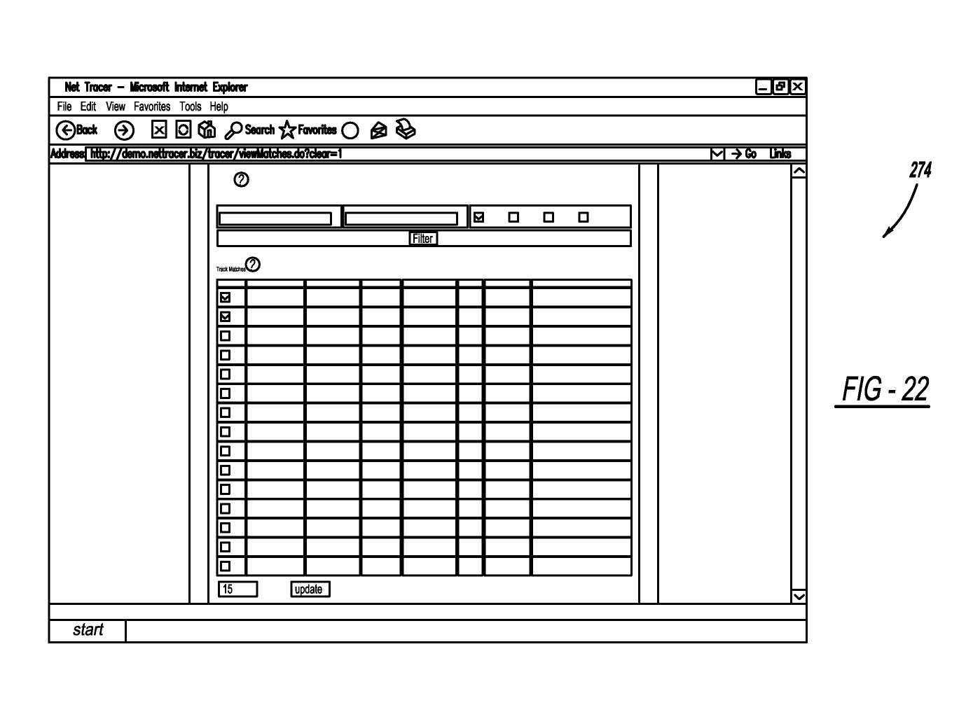

Referring to block 200, if the user 26 selects a tracing option, the methodology advances to block 270, and the user 26 is provided with a screen for actively tracing a lost or misplaced or otherwise mishandled item by matching a found item described in an on hand report with a passenger claim for a lost or misplaced item and described in an incident report as shown in FIG. 21 at 272. A methodology of tracing is described with respect to FIG. 4. The methodology begins in block 300 and active tracing is initiated. The methodology advances to block 305 the user 26 provides an input criteria for performing a trace as shown in FIG. 22 at 274. An example of an input criteria is an incident number. As previously described, the incident number will have a data record associated with it that describes information pertaining to the passenger and attributes of found items. Examples of attributes include claim check number, record locator or bag tag Number, airline Membership Number, Email Address, street Address, name of Passenger, Phone Number (including Home, Business, Mobile, Other); Passenger Itinerary/Bag Itinerary, Name on Bag, Bag Manufacturer; Color; Bag Type; contents or Contents description.

The methodology advances to block 310 and each of the predetermined attributes used to describe an item are assigned a predetermined weight. The predetermined weight is assigned based on factors such as uniqueness of the attribute or relevance or the attribute or the like. The assigned weights may be adjustable. Certain attributes that contribute more to identifying an item may be assigned a higher weight that another attribute. For example, a claim check number is a stronger identifier than a color in determining if there is a match between an on hand item and an item lost by a passenger. Examples of assigned weights to attributes includes:

Claim Check Number—1

Record Locator/bag tag Number—1

Airline Membership Number—1

Email Address—0.85

Street Address—0.15

Name of Passenger—0.50

Phone Number (including Home, Business, Mobile, Other)—0.8

Bag Manufacturer—0.15

Bag Type—0.10

Primary Color—0.20

The methodology advances to block 315 and the methodology compares each of the described attributes for the lost item with each of the described attributes of the on hand item to determine if a comparison exists. For example, an on hand black bag with a lost black bag, or a on hand bag baggage tick with a lost bag baggage ticket. Various comparison techniques may be utilized to determine whether a relationship or match exists between an on hand item attribute and it a corresponding lost item attribute. An example of a comparison technique is a text string comparison. Another example of a technique is a numeric of binary comparison. Still another example of a technique is an alphanumeric comparison. Other techniques or combinations thereof are contemplated. If a comparison between a attribute for the lost item with the corresponding attribute for the found item is made, then the compared attribute pair is identified and the methodology advances to block 320 and a percentage match for the compared attribute pair is determined.

In block 320, the percentage match for the compared attribute pair is determinable using the assigned weight for that particular attribute. The percentage match for the compared attribute pair provides an indicator of the similarity between a pair of attributes. For example, if the claim check number of the found item matches the claim check number of the lost item, the percentage match for the claim check number attribute is 1. Similarly, if the color of the found item matches the color of the lost item, the percentage match for the color attribute is 0.20.

If there is not a match between a lost item attribute with the found item attribute, the percentage match for the compared attribute pair is assigned a value, such as zero. For example, if the claim check number for the found item does not match the claim check number of the lost item, the percentage match for the claim check attribute is assigned a value, such as 0. Similarly, if the color of the found item does not match the color of the lost item, the percentage match for the color attribute is assigned a value, such as 0.

The methodology advances to block 325 and determines an overall percentage match between the mishandled item and the on hand item using each of the attribute pairs. The overall percentage match is determinable using the percentage match for each compared attribute pair, and the assigned weight associated with a particular attribute. For example, the overall percentage match may be calculated by:

Overall Percentage Match=ΣAᵢXᵢ, where A is the assigned weight for a particular attribute i and X is the percentage match for the corresponding attribute pair i.

The methodology advances to block 330, and the methodology compares the overall percentage match to a predetermined match threshold to determine if there is a correlation between the on hand item and lost item in order to resolve the claim for the lost item.

The methodology advances to block 335 and if the overall match percentage is above the predetermined match threshold, the on hand item is identified as a potential match for a lost or otherwise misplaced item. The overall match percentage may be associated with the record file for the on hand item being traced. For example, the overall match percentage and the associated match details are displayed to the user 26. If the overall match percentage is below the predetermined match threshold, the match result may be discarded or otherwise not considered.

In an example of passive tracing, the user 26 may configure the system 10 to automatically accept matches over the match threshold or they may configure the system 10 to allow the user 26 to review each match and accept or reject the match.

Returning back to block 270, the user 26 may select a view trace results tab, and the screen displays a list of all matches for On-hand items matching an incident report in the Lost/Delayed Baggage Report for the user 26's station as shown in FIG. 22 at 274. The match results may be categorized or otherwise filtered. For example, in a passive tracing, match results may be coded within each category based on the percentage of the match as shown below:

Category 1—on primary attributes (such as claim check, frequent flyer ID, email, or record locator) and an overall percentage match of 85% or higher.

Category 2—primary attributes and an overall percentage match between 20%-85%, or if none of the primary attributes pair up, then the minimum percentage will be 60%.

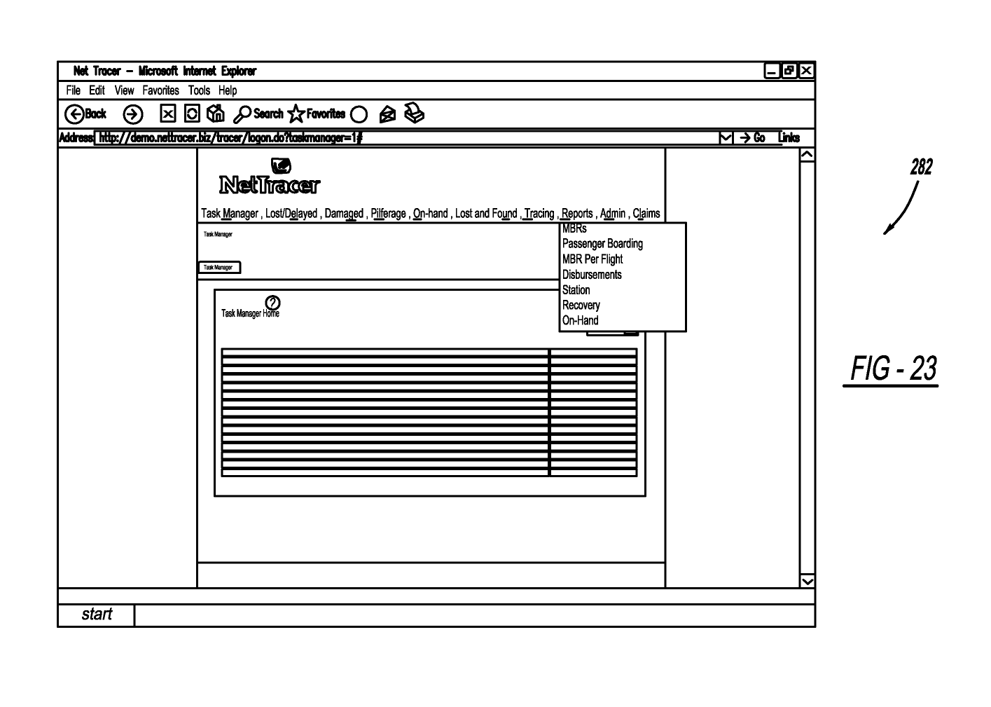

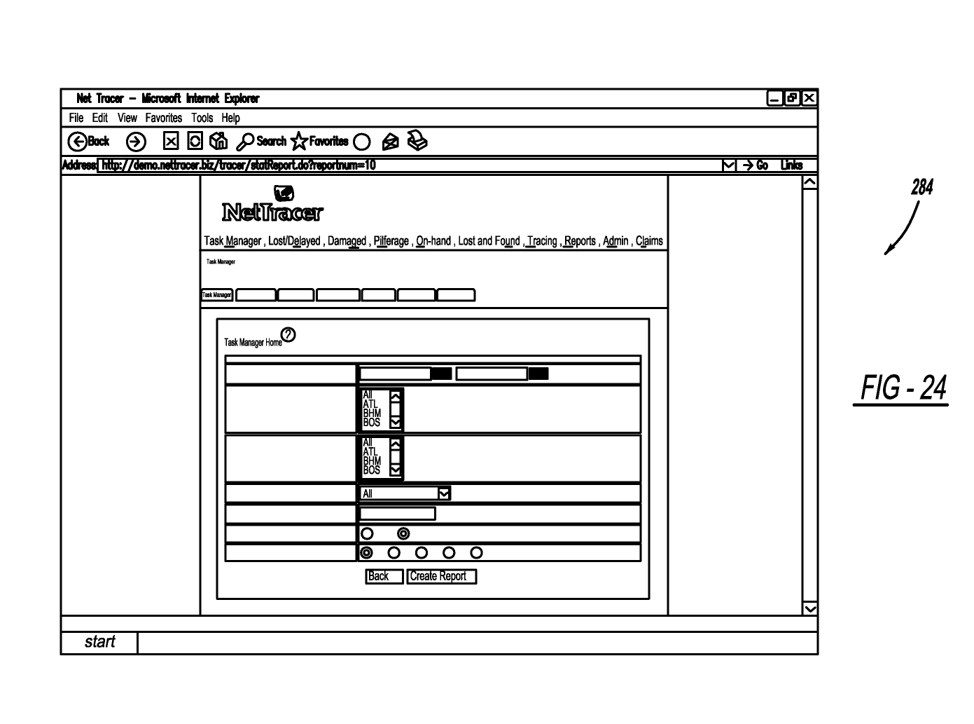

Referring to block 200, if the user 26 selects a report option, the methodology advances to block 280, and the user 26 is provided with a screen for selectively receiving an analytical report as shown in FIG. 23 at 282. These reports may be useful in managing baggage mishandling. The user 26 may select a mishandled bag report and be provided with a screen containing options for filtering or otherwise sorting the data records using predetermined criteria as shown in FIG. 24 at 284. Examples of filtering or sorting criteria include by passenger boarding, incident type such as mishandled or damaged or missing, date range, station, report status, including temporary, pending open or closed, disbursements, on hand, or recovered or the like.

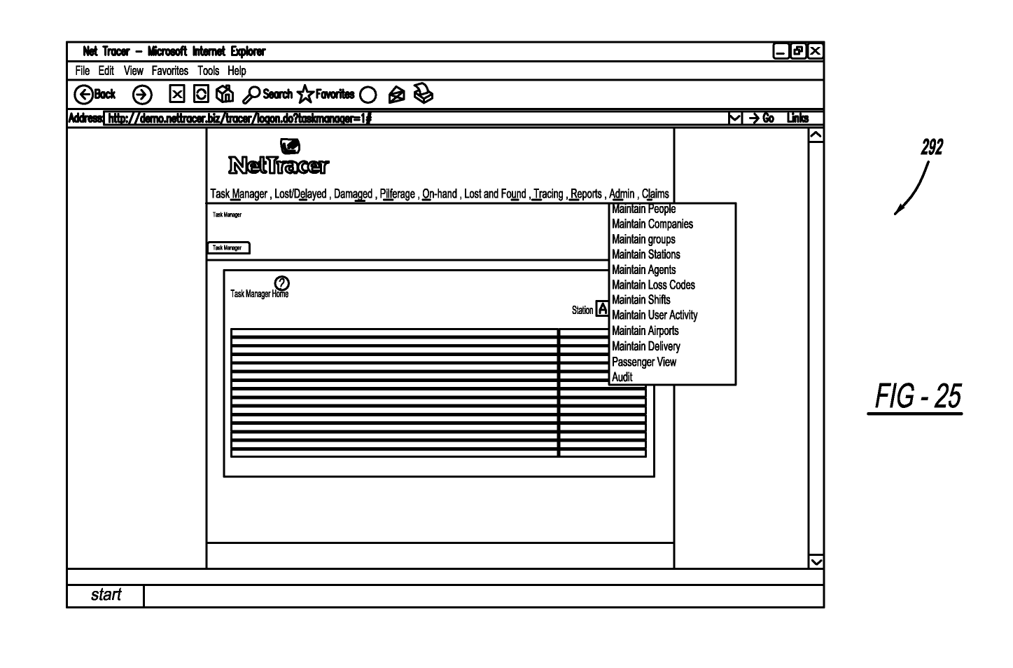

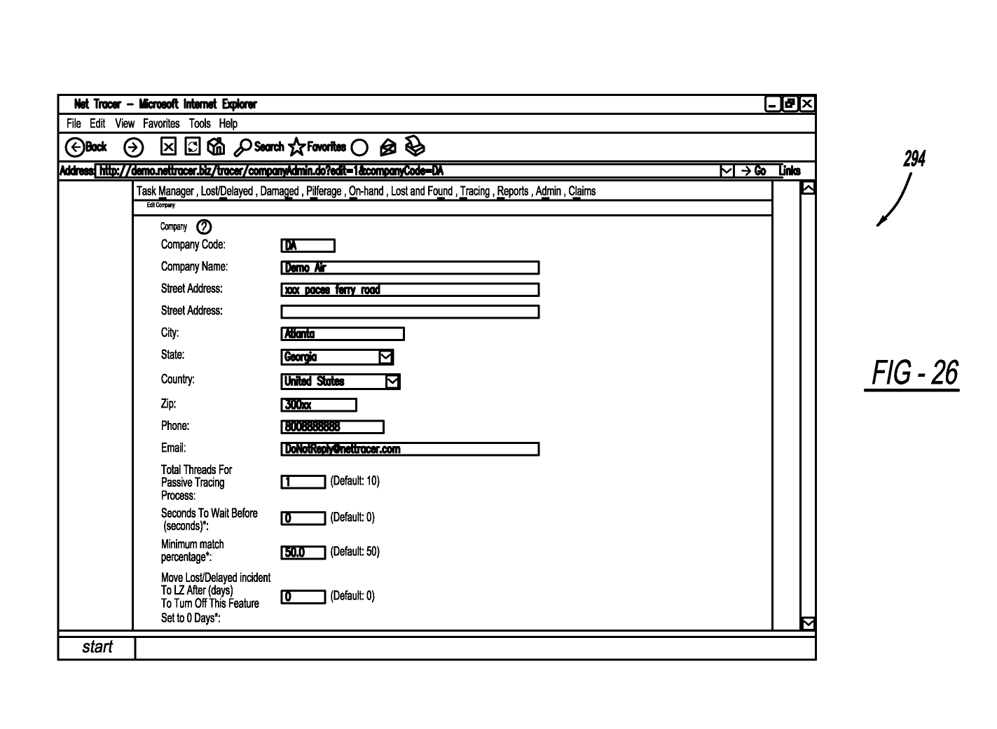

Referring to block 200, if the user 26 selects an administration tab, the methodology advances to block 290, and the user 26 is provided with a drop down menu of various predetermined administrative options from which the user 26 may select as shown in FIG. 25 at 292. The user 26 may selectively maintain the user 26 profile, such as add a user 26, edit an existing user 26 or delete a user 26 or the like. The user 26 may selectively maintain user 26 work shifts. For example, the user 26 may add a shift, edit an existing shift or delete a shift or the like. If the user 26 selects an option to maintain companies, such as an airline, the user 26 may selectively add a company, edit an existing company or delete a company or the like. If the user 26 selects an option to maintain airports, the user 26 may selective an action relative to airports, such as add airports, edit an existing airport or delete an airport or the like. If the user 26 selects an option to maintain groups, the user 26 may selective an action relative to groups, such as add a group, edit an existing group or delete a group, or add agents to a group to add group permissions or the like. If the user 26 selects an option to maintain stations, the user 26 may selective an action relative to stations, such as add a station, edit an existing station or delete a station, or add agents to a station or the like as shown in FIG. 26 at 294. It should be appreciated that these are merely examples of administrative options, and others are contemplated within the administration of the system 10 of tracing described herein.

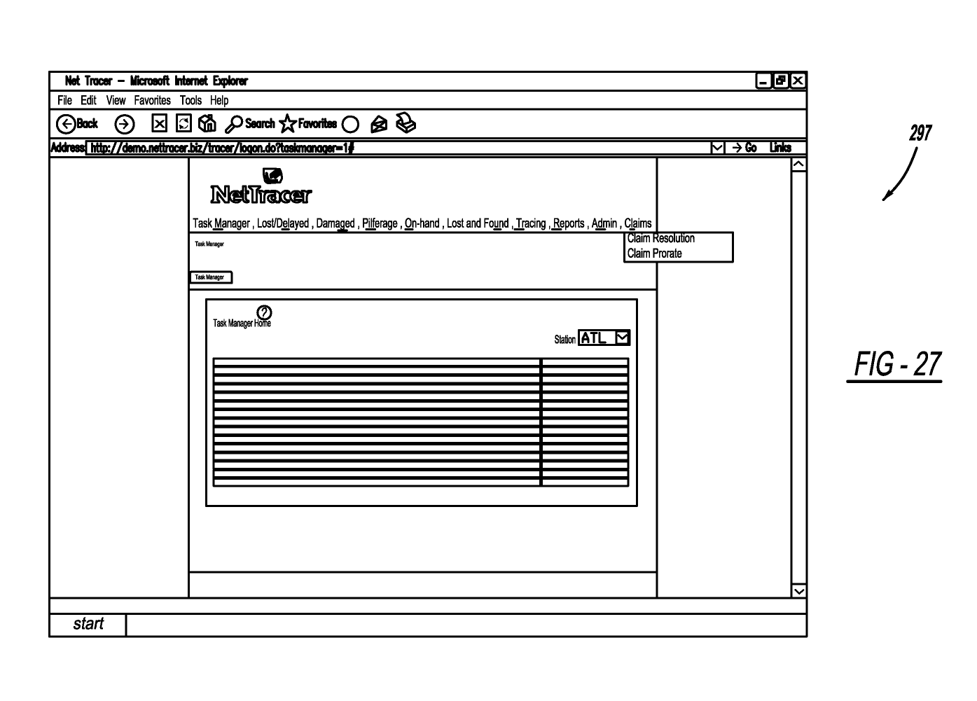

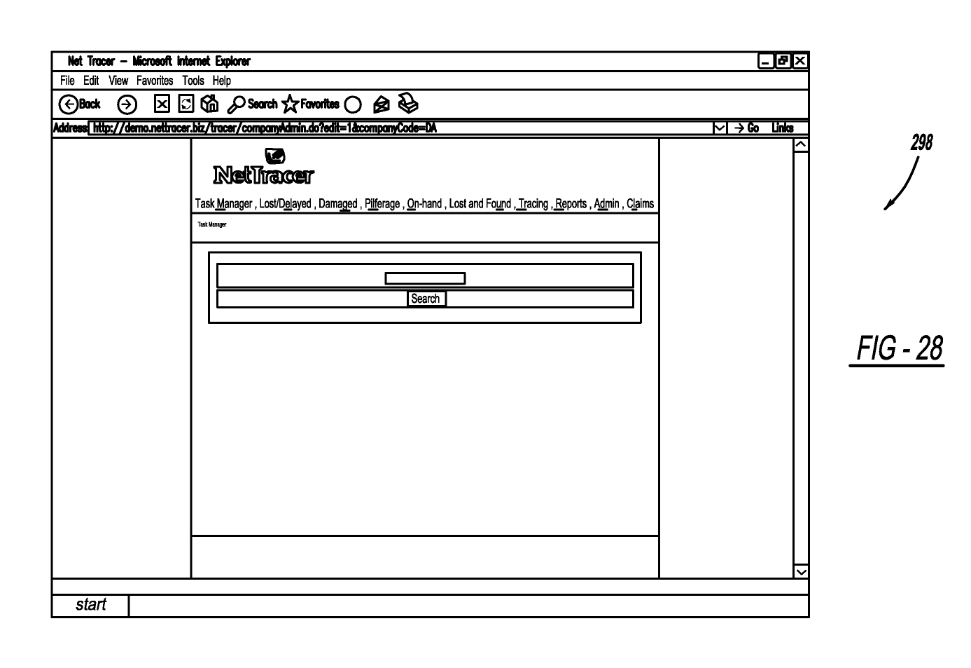

Referring back to block 200, if the user 26 selects a claims option, the methodology advances to block 295 and the user 26 is provided with a screen for processing claims as shown in FIG. 27 at 297. The user 26 may be presented with a screen containing searchable options for finding a claim such as by an incident number. In a claims resolution screen, the user 26 may retrieve a claim by entering a claim or incident number as shown in FIG. 28 at 298. These numbers may be provided via a drop down menu or the like. Information pertaining to a particular claim may be provided to the user 26 such as that regarding previous payments. In addition, the user 26 may create an interim expense payout record for the report and submit the request for approval. The methodology may include rules for approving an interim expense payout, such as a minimum payout cash amount.

The user 26 may select any one of the task management options in any order, and other examples of task management options are contemplated. Many modifications and variations of the present invention are possible in light of the above teachings. Therefore, within the scope of the appended claims, the present invention may be practiced other than as specifically described.

What is claimed is:

1. A method for managing items mishandled during transit using a computer system, said method includes the steps of:
finding an unclaimed item on hand and creating a record for identifying the on hand item using an item tracing software program resident on the computer system, wherein the on hand item record includes predetermined attributes describing the on hand item, and each of the predetermined attributes is assigned a predetermined weight;
creating a record for a mishandled item using the item tracing software program, wherein the mishandled item record includes predetermined attributes describing the mishandled item and each of the predetermined attributes is assigned a predetermined weight;
determining if there is a comparison between each mishandled item attribute and the corresponding on hand item attribute by the item tracing software program, wherein the item tracing software program compares each mishandled item attribute to the corresponding on hand item attribute, and if the mishandled item attribute and corresponding on hand item attribute are comparable, determining a percentage match for each compared attribute pair using the assigned weight corresponding to each attribute;
determining an overall percentage match between the lost item and the on hand item by summing together the weighted percentage match for each compared attribute pair; and
comparing the overall percentage match to a predetermined match threshold and using the overall percentage match to correlate the on hand item with a claim for the mishandled item if the overall percentage match is above the predetermined match threshold.

2. The method as set forth in claim 1 wherein the item tracing software program provides a user with a plurality of predetermined user selectable tracing options on a display device associated with the computer system, wherein the item tracing software program analyzes the tracing option selected by the user using an input device and displays information on the display device corresponding to the user selected tracing option.

3. The method as set forth in claim 2 wherein the tracing option is a task manager option for managing work flow at a predetermined location.

4. The method as set forth in claim 2 wherein the tracing option is a trace results option, and the user is presented with a list of on hand items matching a claim for a mishandled item.

5. The method as set forth in claim 2 wherein the tracing option is a lost or delayed item option for managing lost or delayed items at a predetermined location.

6. The methodology as set forth in claim 2 wherein the tracing option is a damaged item option for managing items damaged in transit.

7. The method as set forth in claim 2 wherein the tracing option is a pilfered bag option for managing baggage that has been pilfered in transit.

8. The method as set forth in claim 2 wherein the tracing option is an on hand item option for managing items physically present at a predetermined location.

9. The methodology as set forth in claim 2 wherein the tracing option is a view trace results option that provides the user with a list of matches of on hand items with the claim for the mishandled item, and each match is categorized based on a likelihood of being a match.

10. The methodology as set forth in claim 2 wherein the tracing option is a claims option that provides the user with a screen for managing the claims for the mishandled item.

11. The method as set forth in claim 1 wherein a user at a predetermined location utilizes a local computer system having a processor, input device and a display screen that is operatively in communication with a main computer system and other local computer systems and via an internet, to manage a claim for the mishandled item using the item tracing software program.

12. The method as set forth in claim 1 wherein the item is baggage transported by an airline.

13. A system for managing items during transit comprising
a main computer system having a server and a database associated with it, wherein the main computer system is at a central location;
a local computer system having a processor, input device and display screen that is operatively in communication with the main computer system via a communications network, wherein the local computer system is at a secondary location;
an item tracing software program associated with the local computer system and the main computer system for managing an unclaimed item on hand at the secondary location or a mishandled item by creating a record identifying the on hand item using predetermined attributes each having a predetermined weight, creating a record for the mishandled item using the predetermined attributes, and comparing the mishandled item record to the on hand item record to determined if there is a match, wherein the item tracing software program compares each mishandled item attribute to the corresponding on hand item attribute, and if a comparison is found between an attribute pair determines a percentage match for each compared attribute pair using the assigned attribute weight and determines an overall percentage match between the lost item and the on hand item by summing together the weighted percentage match for each compared attribute pair and
compares the overall percentage match to a predetermined match threshold to correlate the on hand item with a claim for the mishandled item.

14. The system as set forth in claim 13 wherein the item tracing software program provides a user with a plurality of predetermined user selectable tracing options on the display device associated with the secondary computer system, wherein the item tracing software program analyzes the tracing option selected by the user using the input device and displays information on the display device corresponding to the user selected tracing option.

15. The system as set forth in claim 14 wherein the tracing option is a task manager option for managing work flow at the secondary location, and the secondary location is in communication with other secondary locations via a communications network.

16. The system as set forth in claim 15 wherein the communications network is an Internet.

17. The system as set forth in claim 14 wherein the tracing option is a trace results option, and the user is presented with a list of on hand items matching a claim for the mishandled item.

18. The system as set forth in claim 14 wherein the tracing option is a lost or delayed item option for managing lost or delayed items at the secondary location.

19. The system as set forth in claim 14 wherein the tracing option is a claims option that provides the user with a screen for managing a claim for the mishandled item.

20. The system as set forth in claim 14 wherein the item is baggage transported by an airline.
